(19) United States
(12) Patent Application Publication
(10) Pub. No.: US 2021/0063051 A1
(43) Pub. Date: Mar. 4, 2021

(54) HEAT EXCHANGE METHOD OF TAP WATER, HEAT EXCHANGER, AND WATER HEATING DEVICE

(71) Applicant: KYUNGDONG NAVIEN CO., LTD., Gyeonggi-do (KR)

(72) Inventors: Tae Seong Kwon, Seoul (KR); Soo Hyun Yoon, Seoul (KR); In Chul Jeong, Seoul (KR)

(73) Assignee: KYUNGDONG NAVIEN CO., LTD., Gyeonggi-do (KR)

(21) Appl. No.: 15/930,741

(22) Filed: May 13, 2020

(30) Foreign Application Priority Data
Aug. 26, 2019 (KR) 10-2019-0104266

(51) Int. Cl. F24H 9/00; F28F 21/08; F28F 3/02; F24H 1/14

(52) U.S. Cl. CPC F24H 9/0047; F28F 21/083; F24D 17/0005; F24H 1/145; F28F 3/025

(57) ABSTRACT

Provided are a heat exchange method of tap water using a heat exchanger, and the heat exchanger. The content of residual chlorine in the tap water is about 2 ppm or more, the heat exchanger comprises a plurality of heat plates, which comprise ferritic stainless steel, and copper brazing configured to couple the heat plates, and the ferritic stainless steel contains less than about 0.5 wt % of nickel, about 0.1 wt % to about 2 wt % of copper, and about 0.03 wt % or less of carbon.

### CROSS-REFERENCE TO RELATED APPLICATIONS

This application claims the priority of Korean Patent Application No. 10-2019-104226 filed on Aug. 26, 2019, in the Korean Intellectual Property Office, the disclosure of which is incorporated herein by reference.

### BACKGROUND OF THE INVENTION

### Field of the Invention

The present invention relates to a heat exchanger having excellent corrosion resistance against tap water containing high contents of fluorine and residual chlorine, a heat exchange method of the tap water using the same, and a water heating device.

### Description of the Related Art

Stainless steel generally refers to an iron (Fe) alloy in which the content of chromium (Cr) is about 12 wt % or more, and depending on types and amounts of additive elements, the stainless steel is classified into ferritic, austenitic, martensitic, precipitation hardening stainless steel, and the like. The stainless steel has been used across industries as a material fora structural component or a mechanical component such as a heat exchanger, a material for high and lower temperature, tableware, and an exhaust pipe.

As a bonding method of the stainless steel, brazing has been widely used because the brazing enables mass production, facilitates bonding, and does not require a process after the bonding. A brazing alloy is a material that fills a space between base materials or is applied therebetween for bonding the base materials. The brazing alloy has to have good wettability with the base materials and an appropriate melting point. Also, the brazing alloy has to have affinity with the base materials when brazing and appropriate physical/mechanical properties. The considerations in selecting the brazing alloy are a type of abase material, a brazing method, a cost of an alloy, a shape of a base material, a melting point and a melting temperature range of an alloy, brazing strength, and the like.

Also, a heat exchanger is used to warm an interior space and heat water in general homes, public buildings, or the like. In a general heat exchanger, oil or gas is used as a fuel and combusted through a burner. Then, heat of combustion generated during a combustion process is used to heat water. The heated water is circulated within the interior and used to warm the interior space and heat water as needed.

In detail, Korean Patent Publication No. 2011-0072237 (patent document 1) discloses a high corrosion-resistant aluminum alloy which is for a heat exchanger tube and comprises iron, silicon, manganese, copper, zirconium and/or boron, and aluminum and impurities. However, because components such as fluorine and residual chlorine contained in tap water for each country are different from each other, a difference in corrosion resistance occurs even though the same heat exchanger is used. This may cause the occurrence of excessive water leakage in a specific country. As described above, the excessive water leakage degrades the overall quality and reliability of the heat exchanger, and various types of safety accidents may occur.

Therefore, there is a need for the research and development on a heat exchange method of tap water containing high contents of fluorine and residual chlorine and a heat exchanger having excellent corrosion resistance against tap water.

### SUMMARY OF THE INVENTION

An aspect of the present invention provides a heat exchanger having excellent corrosion resistance against tap water containing high contents of fluorine and residual chlorine, a heat exchange method of the tap water using the same, and a water heating device.

According to an aspect of the present invention, there is provided a heat exchange method of tap water using a heat exchanger, wherein the content of residual chlorine in the tap water is about 2 ppm or more, the heat exchanger comprises a plurality of heat plates, which comprise ferritic stainless steel, and copper brazing configured to couple the heat plates, and the ferritic stainless steel contains less than about 0.5 wt % of nickel, about 0.1 wt % to about 2 wt % of copper, and about 0.03 wt % or less of carbon.

According to another aspect of the present invention, there is provided a heat exchanger for exchanging heat of tap water in which the content of residual chlorine is about 2 ppm or more, the heat exchanger including a plurality of heat plates and copper brazing configured to couple the heat plates, wherein each of the heat plates comprises ferritic stainless steel, and the ferritic stainless steel contains less than about 0.5 wt % of nickel, about 0.1 wt % to about 2 wt % of copper, and about 0.03 wt % or less of carbon.

According to another aspect of the present invention, there is provided a plate-type heat exchanger to be used in a water heating device configured to heat tap water to produce hot water, the plate-type heat exchanger including: a plurality of heat plates, each of which comprises a body portion having a plate shape and an extension portion extending outward from one end of the body portion, the heat plates being stacked on each other in a predetermined direction so that two neighboring extension portions overlap each other; and bonding parts, each of which is provided between the two neighboring extension portions to bond the two neighboring heat plates, wherein the heat plate is made of ferritic stainless steel containing less than about 0.5 wt % of nickel, about 0.1 wt % to about 2 wt % of copper, and about 0.03 wt % or less of carbon, and the bonding part is formed by brazing with a copper filler metal.

According to another aspect of the present invention, there is provided a water heating device configured to heat tap water to produce hot water, the water heating device including: a heat source unit; and a plate-type heat exchanger configured to heat the tap water using heat that is generated in the heat source unit or using heating water that is heated by the heat generated in the heat source unit, wherein the plate-type heat exchanger comprises: a plurality of heat plates, each of which comprises a body portion having a plate shape and an extension portion extending outward from one end of the body portion, the heat plates being stacked on each other in a predetermined direction so that two neighboring extension portions overlap each other; and a plurality of bonding parts, each of which is provided between the two neighboring extension portions to bond the two neighboring heat plates, wherein the heat plate is made of ferritic stainless steel containing less than about 0.5 wt % of nickel, about 0.1 wt % to about 2 wt % of copper, and about 0.03 wt % or less of carbon, and the bonding part is formed by brazing with a copper filler metal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a plate-type heat exchanger according to the present invention;

FIG. 2 is a cross-sectional view illustrating a plate-type heat exchanger of the related art;

FIG. 3 is a perspective view illustrating a plate-type heat exchanger according to the present invention;

FIG. 4 is a conceptual view illustrating a water heating device according to the present invention;

FIGS. 5 to 7 are photographs of cross-sections of specimens manufactured in an embodiment and comparative examples and photographs of cross-sections after etching; and

FIG. 8 is a result of corrosion resistance evaluation for the specimens manufactured in the embodiment and the comparative examples.

### DETAILED DESCRIPTION OF THE PREFERRED EMBODIMENT

Hereinafter, the present invention will be described in detail.

The terminology used herein is for the purpose of describing particular exemplary embodiments only and is not intended to be limiting of the invention. As used herein, the singular forms “a”, “an” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” comprises any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 90, 8%, 7%, 6%, 5%, 4%, 3%, 2%, 1%, 0.50, 0.10, 0.050, or 0.010 of the stated value. Unless otherwise clear from the context, all numerical values provided herein are modified by the term “about.”

In the present disclosure, when any member is located “on” another member, this comprises a case in which still another member is present between both members as well as a case in which one member is in contact with another member.

Heat Exchanger

A heat exchanger according to the present invention is for exchanging heat of tap water in which the content of residual chlorine is about 2 ppm or more, and the heat exchanger comprises a plurality of heat plates and copper brazing that couples the heat plates. Here, the heat exchanger may have a structure of a heat exchanger in which tap water and heating water are generally used.

Heat Plate

A heat plate comprises ferritic stainless steel. In a case of exchanging heat of tap water having high conductivity, that is, tap water containing high contents of corrosive materials, galvanic corrosion may occur due to potential difference between the stainless steel and copper brazing. As described above, the brazed copper is washed away due to the galvanic corrosion, and thus degradation in corrosion resistance of the heat exchanger may occur. In a case in which the heat plate comprises the ferritic stainless steel, the galvanic corrosion described above is prevented even though the tap water having high conductivity is used, and thus the degradation in corrosion resistance of the heat exchanger may be prevented.

Here, the ferritic stainless steel contains less than about 0.5 wt % of nickel, about 0.1 wt % to about 2 wt % of copper, and about 0.03 wt % or less of carbon. In detail, the ferritic stainless steel may contain about 0.3 wt % to about 2 wt % or about 0.3 wt % to about 1 wt % of copper, less than about 0.03 wt % or about 0.02 wt % to about 0.03 wt % of carbon, and about 16 wt % to about 23 wt % of chromium, but may be substantially free of nickel. The content of each of the components is based on the total weight of the ferritic stainless steel.

Also, the copper in the heat plate serves for preventing degradation in corrosion resistance of the heat exchanger due to liquid metal embrittlement (LME) phenomenon and abnormal structures. When the content of copper is within in the range described above, there is no change in corrosion resistance of the heat exchanger due to the copper brazing.

Furthermore, the copper in the heat plate is coupled to the chromium during the copper brazing, and thus chromium carbide is produced. Accordingly, a chromium depletion layer is formed therearound, and the corrosion resistance of the heat exchanger may be degraded. Thus, when the content of carbon is within the range described above, production of the chromium carbide due to the copper brazing is suppressed, and thus the degradation of corrosion resistance of the heat exchanger may be prevented.

Furthermore, by the chromium in the heat plate, a very thin chromium oxide (Cr₂O₃) layer is formed on a surface thereof. This layer acts as a passive layer for blocking oxygen that permeates a metal substrate, and thus serves for preventing corrosion and improving corrosion resistance. When the content of chromium is within the range described above, even though chromium carbide (Cr₃C₂) is partially produced during the copper brazing, a chromium oxide film is maintained by the remaining chromium. Thus, the corrosion resistance of the heat plate may be maintained.

Also, it is generally known that austenitic stainless steel containing nickel has more excellent corrosion resistance than the ferritic stainless steel. However, when two or more stainless steel sheets are brazed with copper, because corrosion resistance on a brazing section, that is, at a position in which the stainless steel and the copper are coupled to each other has lower properties than corrosion resistance of a base material itself, the corrosion resistance on the brazing section is more essential than the corrosion resistance of the base material itself. Particularly, in an environment in which, as in a plate-type heat exchanger, a heat exchanger is exposed to a temperature of about 40° C. to about 80° C. higher than a room temperature while being continuously in contact with tap water including corrosive materials, such as, chlorine ions, sulfate ions, and residual chlorine, a copper brazing portion of the ferritic stainless steel may have excellent corrosion resistance than that of a copper brazing portion of the austenitic stainless steel, when considering in terms of degradation in corrosion resistance due to a liquid metal embrittlement (LME) phenomenon and abnormal structures, a possibility of occurrence of galvanic corrosion, and the like.

Copper Brazing

Copper brazing has a role in coupling the heat plates. In a case in which the heat exchanger according to the present invention comprises the copper brazing, more excellent economic feasibility is obtained when compared to a case in which another metal brazing, such as, nickel is used.

Here, the copper brazing may comprise tin (Sn), zinc (Zn), and the like for the purpose of lowering a melting point of the copper or nickel (Ni), silver (Ag), and the like for the purpose of improving strength or wettability. For example, the copper brazing may be a brazing alloy in which the silver and the copper are contained in a weight ratio of about 20 to about 35:about 65 to about 80.

Tap Water

In tap water used in the heat exchanger according to the present invention, the content of residual chlorine has a high concentration of about 2 ppm or more. In detail, the tap water may contain about 2 ppm to about 5 ppm of residual chlorine, about 0.5 ppm to about 2 ppm of fluorine, and about 250 ppm to about 500 ppm of sulfate ions.

The tap water may be heated by the heat exchange. In detail, the heat exchanger may be a hot water supply heat exchanger for supplying tap water as hot water through the heat exchange performed between the tap water and heating water heated in a main heat exchanger of a boiler.

For example, the tap water having a temperature of about 0° C. to about 20° C. is heated into hot water having a temperature of about 40° C. to about 60° C. by the heat exchange. In detail, in the heat exchanger, the tap water having a temperature of about 0° C. to about 20° C. is heated into hot water having a temperature of about 40° C. to about 60° C., by the heat exchange with the heating water having a temperature of about 50° C. to about 80° C.

The heat exchanger of the present invention as described above has the excellent corrosion resistance against tap water containing high contents of the corrosive materials, for example, sulfate ions, chlorine ions, and residual chlorine, and also has the excellent economic feasibility.

Plate-Type Heat Exchanger

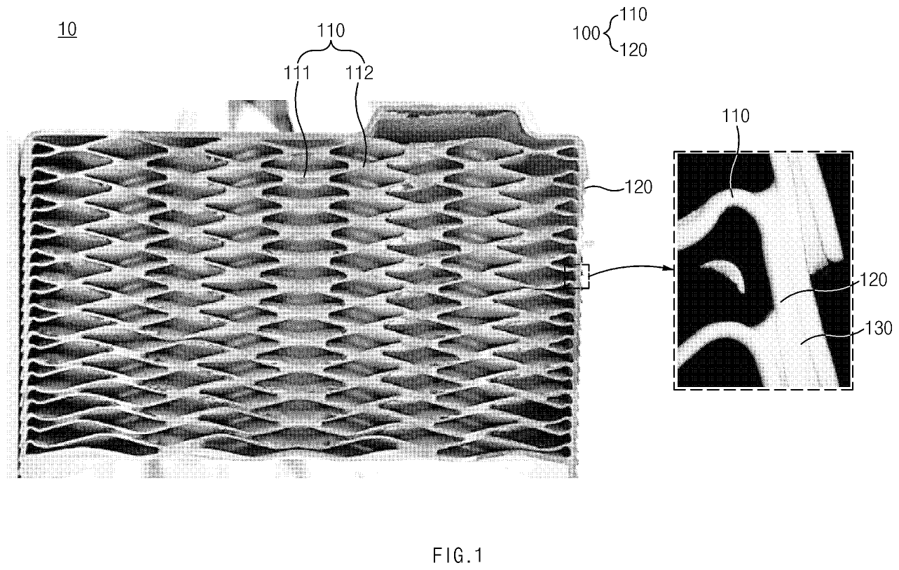

A plate-type heat exchanger according to the present invention may be a plate-type heat exchanger to be used in a water heating device that heats tap water to produce hot water. As illustrated in FIG. 1, a plate-type heat exchanger 10 according to the present invention may comprise a plurality of heat plates 100 and bonding parts 130. FIG. 1 is a cross-sectional view illustrating a plate-type heat exchanger according to the present invention. The content of the residual chlorine of the tap water supplied to the plate-type heat exchanger according to the present invention may be about 2 ppm or more.

Heat Plates 100

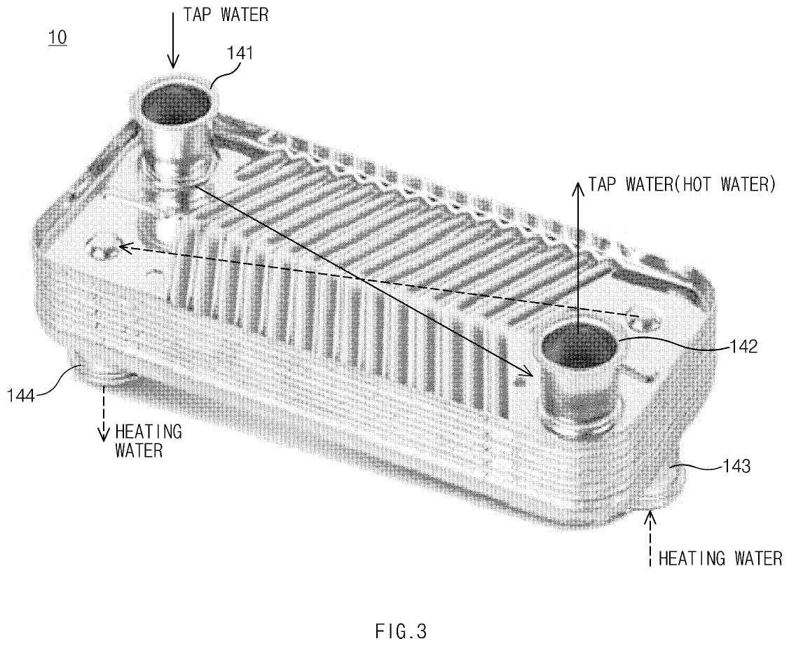

Each of the heat plates 100 comprises a body portion 110 and an extension portion 120. The body portion 110 may be a plate-shaped portion as illustrated in FIG. 1. In the body portion 110, a predetermined pattern may be defined. For example, in the body portion 110, a herringbone pattern of valleys 111 and crests 112 may be defined. Through the predetermined pattern, heat exchange areas may be maximized. In the neighboring heat plates 100, the predetermined patterns may be defined in directions opposite to each other. For example, as illustrated in FIG. 3 described later, one heat plate may have a V-shaped pattern that opens in the right direction, and another heat plate adjacent thereto may have a V-shaped pattern that opens in the left direction. In a field of the plate-type heat exchanger, it is general that the herringbone pattern of valleys and crests is defined therein, and thus its detailed descriptions will be omitted herein. The extension portion 120 may be a portion extending outward from one end of the body portion 110. The extension portion 120 may be a portion inclinedly extending outward from the one end of the body portion 110. A bonding part 130, which will be described later, is provided between two neighboring extension portions 120.

As described above, the heat plate 100 is made of ferritic stainless steel containing less than about 0.5 wt % of nickel, about 0.1 wt % to about 2 wt % of copper, and about 0.03 wt % or less of carbon.

In the plate-type heat exchanger 10, the plurality of heat plates 100 may be stacked in a predetermined direction. In FIG. 1, the heat plates 100 stacked in a vertical direction are illustrated. The plurality of heat plates 100 are stacked such that the two neighboring extension portions 120 overlap each other.

Bonding Part 130

The bonding part 130 is for bonding the two neighboring heat plates 100 to each other and is disposed between the two neighboring extension portions 120. Since the bonding part 130 may be disposed in each of spaces between all of the extension portions 120, a plurality of bonding parts 130 may be provided. As described above, the bonding part 130 is formed by brazing with a copper filler metal.

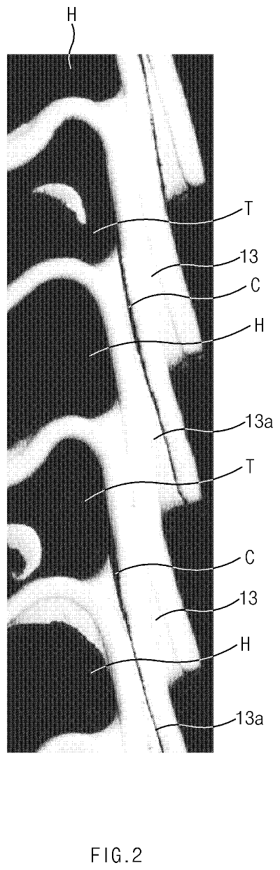

In a case in which the plate-type heat exchanger is a hot water supply heat exchanger, a flow path T through which tap water flows a flow path H through which heating water flows may be provided, as illustrated in FIG. 2. For example, when three heat plates sequentially disposed among the heat plates 100 are referred to as first, second, and third heat plates, a tap water flow path T through which the tap water flows may be defined between the first heat plate and the second heat plate, and a heating water flow path H through which the heating water flows may be defined between the second heat plate and the third heat plate. Thus, heat exchange may indirectly occur between the tap water and the heating water. FIG. 2 is a cross-sectional view illustrating a plate-type heat exchanger of the related art. Also, the inventors of the present invention have conducted studies and found that, among bonding parts 13 and 13a in the plate-type heat exchanger of the related art, crevices C having a crack shape are formed in the bonding parts 13a that is in contact with the tap water. The crevices C cause leakage of the tap water. However, in the plate-type heat exchanger 10 according to the present invention, the possibility of the crevices is very low.

Here, as illustrated in FIG. 3, the plate-type heat exchanger 10 according to the present invention may comprise a tap water inlet 141 through which the tap water enters, a tap water outlet 142 through which the tap water, which is indirectly heated by the heating water, that is, hot water is discharged, a heating water inlet 143 through which the heating water enters, and a heating water outlet 144 through which the heating water after the heat exchange is discharged. The tap water entering the tap water inlet 141 is divided into a plurality of tap water flow paths T (see FIG. 2) and then flows through each of the tap water flow paths T. Subsequently, the tap water may be combined into one flow and discharged thought the tap water outlet 142. This is true for the heating water. In an example illustrated in FIG. 3, the heat exchanger is provided such that the tap water and the heating water flow in directions opposite to each other.

Water Heating Device

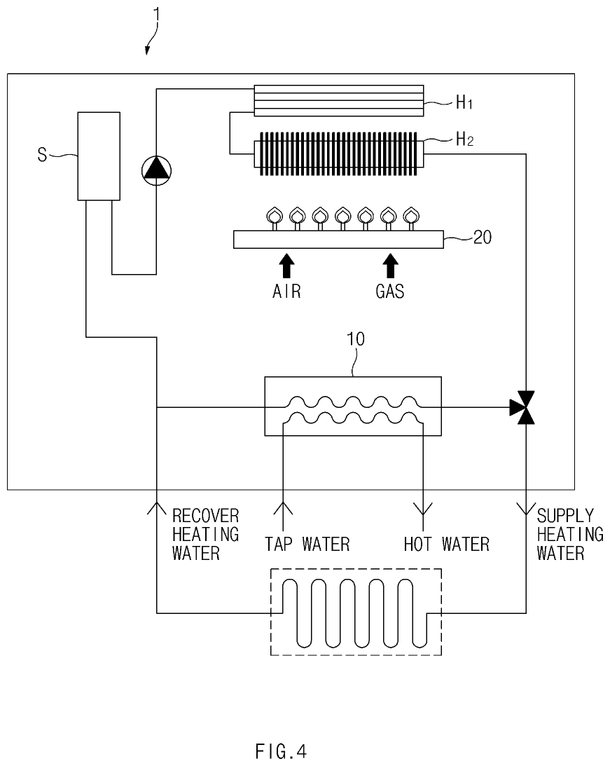

A water heating device according to the present invention may be a water heating device that heats tap water to produce hot water. As illustrated in FIG. 4, a water heating device 1 according to the present invention may comprise a plate-type heat exchanger 10 and a heat source unit 20. FIG. 4 is a conceptual view illustrating a water heating device according to the present invention.

The heat source unit 20 may be a component for generating heat. The heat source unit 20 may be a burner which receives fuel gas or oil and generates heat through a combustion reaction. Alternatively, the heat source unit 20 may be a heating body that receives electricity and radiates heat.

The plate-type heat exchanger 10 comprises heat plates 100 and bonding parts 130 described above. The plate-type heat exchanger 10 heats the tap water through the heat exchange. Here, the heat for heating the tap water may be transferred from heat that is generated in the heat source unit 20 or heating water that is heated by the heat generated in the heat source unit 20. In FIG. 4, a water heating device that heats the tap water using the heating water is illustrated. The heating water is supplied to a heating target and provides heat to the heating target. Subsequently, the heating water is recovered and heated in a heat exchanger. Here, the heat exchanger may be the main heat exchanger mentioned above and may comprise a latent heat exchanger H₁ and a sensible heat exchanger H₂. In an example of FIG. 4, the heat provided to the heat exchanger may be provided from the heat source unit 20. The heating water heated in the heat exchanger is supplied to the plate-type heat exchanger 10 and then may heat the tap water.

However, the water heating device is not limited thereto. For example, the water heating device may be a boiler for providing the heating, a water heater for providing hot water (a direct heating-type water heater that is not equipped with a separate hot water tank or a tank-type water heater equipped with a separate hot water tank), or a boiler having a water heater function.

The tap water supplied to the water heating device may be tap water in which the content of residual chlorine is about 2 ppm or more. As described above, the heat plate 100 may be made of ferritic stainless steel containing less than about 0.5 wt % of nickel, about 0.1 wt % to about 2 wt % of copper, and about 0.03 wt % or less of carbon. The bonding part 130 may be formed by brazing with a copper filler metal. At least some of the bonding parts 130 may be provided to be in contact with the tap water that enters the plate-type heat exchanger 10 (see FIG. 2).

Heat Exchange Method of Tap Water

A heat exchange method of tap water according to the present invention is a method for exchanging heat of the tap water, in which the content of residual chlorine is about 2 ppm or more, by using a heat exchanger that comprises heat plates, including ferritic stainless steel, and copper brazing.

The heat exchange is performed through a refrigerant or a heat exchange medium. The heat exchange medium flows in one side of a tube that is a place for heat exchange, and the heat exchange with another medium in the other side of the tube is performed. The tap water may be heated by the heat exchange. In detail, the heat exchange may be a hot water supply heat exchange for supplying tap water as hot water through the heat exchange between the tap water and heating water heated in a main heat exchanger of a boiler.

For example, the tap water having a temperature of about 0° C. to about 20° C. is heated into hot water having a temperature of about 40° C. to about 60° C. by the heat exchange. In detail, by the heat exchange method, the tap water having a temperature of about 0° C. to about 20° C. is heated into hot water having a temperature of about 40° C. to about 60° C., by the heat exchange with the heating water having a temperature of about 50° C. to about 80° C.

The tap water may contain about 0.5 ppm to about 2 ppm of fluorine and about 250 ppm to about 500 ppm of sulfate ions.

Also, the ferritic stainless steel contains about 0.3 wt % to about 2 wt % of copper, about 0.03 wt % or less of carbon, and about 16 wt % to about 23 wt % of chromium, but the ferritic stainless steel may be substantially free of nickel.

Here, the heat plates, the copper brazing, and the tap water are the same as those of the heat exchanger described above.

Hereinafter, the present invention will be described in more detail with reference to embodiments. However, these embodiments are provided to assist understanding of the present invention, and the scope of the present invention is not limited to the embodiments in any sense.

### EMBODIMENT

### Embodiment 1

Stainless steel having an average thickness of about 0.3 mm and including KS STS430J1L (composition:about 18 wt % of Cr—about 0.5 wt % Cu—about 0.025 wt % of C, Ni not contained, and ferritic type) was used as heat plates, and the two heat plates were coupled to each other with copper brazing (manufacturer: POUDMET, and product name: BCu-1A). Thus, a copper-brazed specimen of a heat exchanger was manufactured.

### Comparative Example 1

Except that KS STS 316L (composition:about 17 wt % of Cr—about 13 wt % of Ni—about 2.5 wt % of Mo—about 0.03 wt % of C, Cu not contained, and austenitic type) was used as heat plates, a specimen was manufactured by the same method as Embodiment 1.

### Comparative Example 2

Except that KS STS 304 (composition:about 19 wt % of Cr—about 9 wt % of Ni—about 2 wt % of Mn—about 0.08 wt % of C, Cu not contained, and austenitic type) was used as heat plates, a specimen was manufactured by the same method as Embodiment 1.

### Comparative Example 3

Except that KS STS 304L (composition:about 19 wt % of Cr—about 11 wt % of Ni—about 2 wt % of Mn—about 0.03 wt % of C, Cu not contained, and austenitic type) was used as heat plates, a specimen was manufactured by the same method as Embodiment 1.

### Experimental Example 1. Observation of Cross-Section

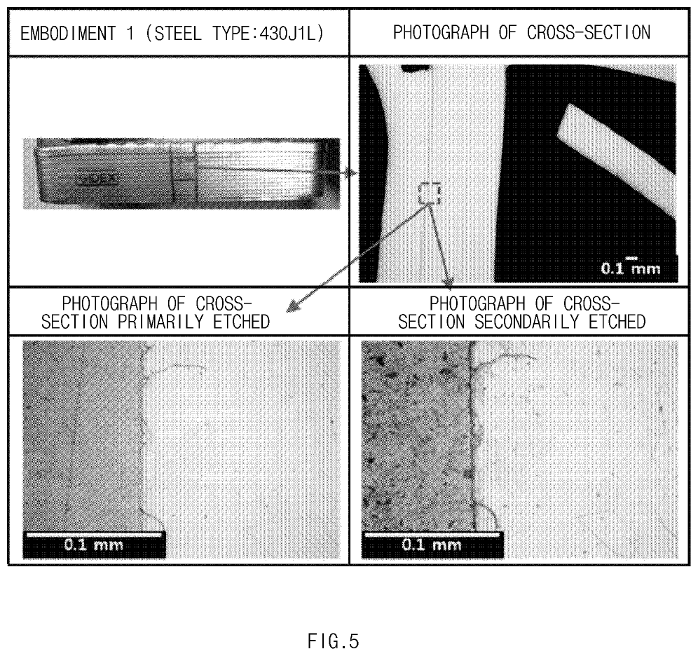

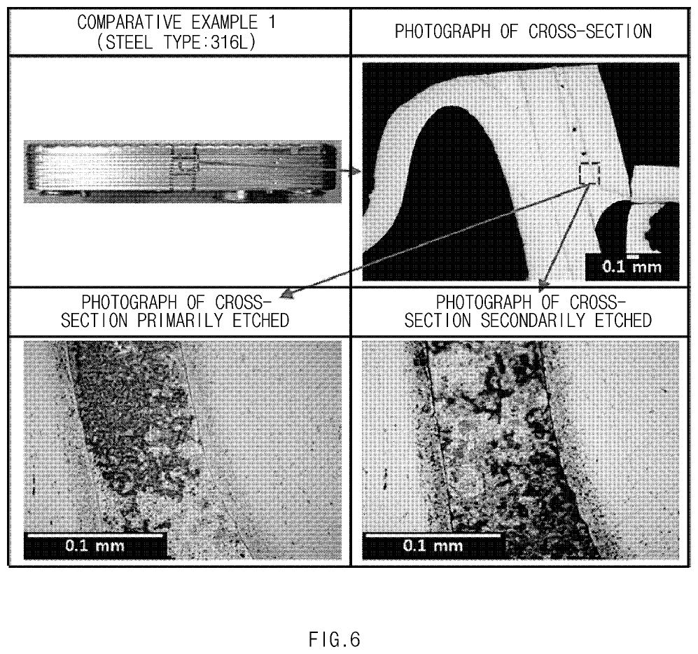

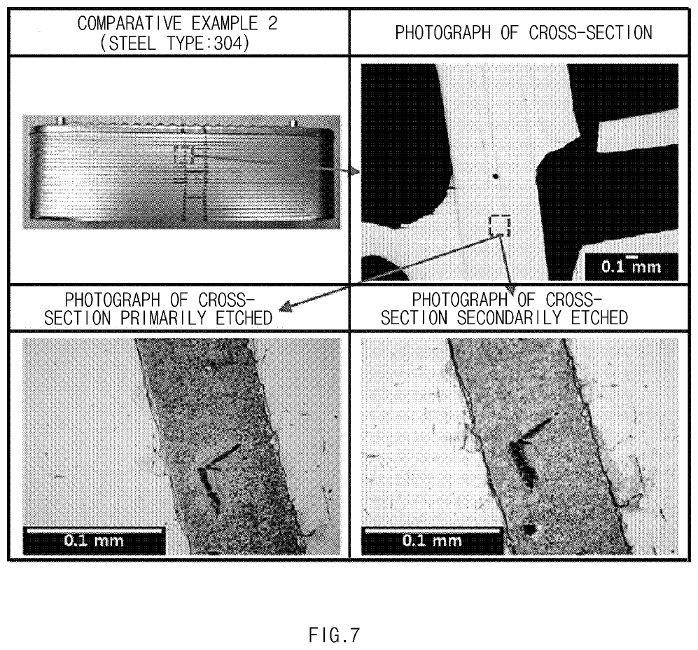

Cross-sections of the specimens of the heat exchangers manufactured in the embodiment and the comparative examples were observed using an optical microscope. The cross-sections were immersed in an oxalic acid for about 1 minute and primarily etched by an electrical etching method. Then, the cross-sections were observed. The cross-sections were secondarily etched by the same method described above and then observed. The observed cross-sections are shown in FIGS. 5 to 7. FIG. 5 are photographs of the cross-section of the specimen of Embodiment 1. FIG. 6 are photographs of the cross-section of the specimen of Comparative example 1. FIG. 7 are photographs of the cross-section of the specimen of Comparative example 2.

As shown in FIG. 5, in the specimen of Embodiment 1, a boundary line between the copper brazing and the heat plate is smooth, and there is no trace of diffusion of the copper toward the ferritic stainless steel. Also, when the cross-section is etched, grain boundary sensitization of the ferritic stainless steel is not observed.

As shown in FIG. 6, in the specimen of Comparative example 1, there is a trace of diffusion of the copper toward the ferritic stainless steel. When the cross-section is etched, the copper is observed in a ferritic stainless steel grain boundary. On the other hand, when the cross-section is etched, sensitization is not observed in a grain boundary of the ferritic stainless steel.

As shown in FIG. 7, in the specimen of Comparative example 2, there is a trace of diffusion of the copper toward the ferritic stainless steel. When the cross-section is etched, the copper is observed in a ferritic stainless steel grain boundary. Also, when the cross-section is etched, sensitization is observed in a grain boundary of the ferritic stainless steel.

### Experimental Example 2. Evaluation of Corrosion Resistance

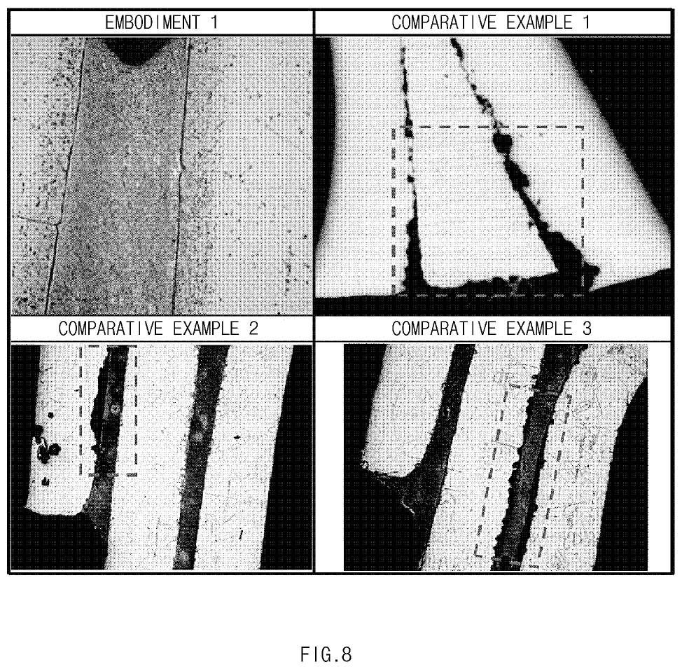

The cross-sections of the specimens of the heat exchangers manufactured in the embodiment and the comparative examples were immersed in test water and treated for about 168 hours. Then, the cross-sections are observed by the same method as Experimental example 1. Here, the test water contains about 5 ppm of residual chlorine, about 1,200 ppm of MgSO₄, and about 5 wt % of NaCl, and was maintained at about 80° C. The observed cross-sections are shown in FIG. 8.

As illustrated in FIG. 8, there is no corrosion in the specimen of Embodiment 1. On the other hand, the specimens of Comparative example 1 to Comparative example 3 have insufficient corrosion resistance against the test water containing high contents of the residual chlorine, and thus boundary corrosion occurs between the copper brazing and the heat plate.

As described above, as the result of evaluation of corrosion resistance, the heat exchanger including the heat plate and the copper brazing of Embodiment 1 has excellent corrosion resistance against the tap water containing the high contents of the residual chlorine and the sulfate ions. Thus, it is apparent that there is no boundary corrosion between the copper brazing and the heat plate. Therefore, even though the heat exchanger of the present invention as described above is used for heat exchange of the tap water containing the high contents of the residual chlorine and the sulfate ions, a replacement period of the heat exchanger due to corrosion may not be shortened.

The heat exchanger of the present invention has the excellent corrosion resistance against tap water containing high contents of corrosive materials, for example, sulfate ions, chlorine ions, and residual chlorine, is easy to obtain, and has the excellent economic feasibility because inexpensive copper brazing is used. Particularly, in the heat exchanger, the ferritic stainless steel having little galvanic potential difference with the copper used in the brazing is used as the heat plate, and thus the galvanic corrosion is prevented. Also, the stainless steel including the copper is used as the heat plate, and thus degradation of the corrosion resistance due to the liquid metal embrittlement (LME) phenomenon and the abnormal structures does hardly occur. Also, in the heat exchanger, the stainless steel containing the low content of carbon is used as the heat plate, and thus the degradation of corrosion resistance due to the chromium carbide is prevented. Thus, the excellent corrosion resistance is obtained.

While the present invention has been shown and described in connection with the exemplary embodiments, it will be apparent to those skilled in the art that modifications and variations can be made without departing from the spirit and scope of the invention as defined by the appended claims.

What is claimed is:

1. A heat exchange method of tap water using a heat exchanger, wherein
the content of residual chlorine in the tap water is about 2 ppm or more,
the heat exchanger comprises a plurality of heat plates, which comprise ferritic stainless steel, and copper brazing configured to couple the heat plates, and
the ferritic stainless steel contains less than about 0.5 wt % of nickel, about 0.1 wt % to about 2 wt % of copper, and about 0.03 wt % or less of carbon.

2. The heat exchange method of claim 1, wherein the tap water contains about 0.5 ppm to about 2 ppm of fluorine and about 250 ppm to about 500 ppm of sulfate ions.

3. The heat exchange method of claim 1, wherein the ferritic stainless steel contains about 0.3 wt % to about 2 wt % of copper, about 0.03 wt % or less of carbon, and about 16 wt % to about 23 wt % of chromium, wherein the ferritic stainless steel is substantially free of nickel.

4. The heat exchange method of claim 1, wherein the tap water is heated by the heat exchange.

5. The heat exchange method of claim 4, wherein the tap water having a temperature of about 0° C. to about 20° C. is heated into hot water having a temperature of about 40° C. to about 60° C. by the heat exchange.

6. A heat exchanger for exchanging heat of tap water in which the content of residual chlorine is about 2 ppm or more, the heat exchanger comprising
a plurality of heat plates and copper brazing configured to couple the heat plates,
wherein each of the heat plates comprises ferritic stainless steel, and
the ferritic stainless steel contains less than about 0.5 wt % of nickel, about 0.1 wt % to about 2 wt % of copper, and about 0.03 wt % or less of carbon.

7. The heat exchanger of claim 6, wherein the tap water contains about 0.5 ppm to about 2 ppm of fluorine and about 250 ppm to about 500 ppm of sulfate ions.

8. The heat exchanger of claim 6, wherein the ferritic stainless steel contains about 0.3 wt % to about 2 wt % of copper, about 0.03 wt % or less of carbon, and about 16 wt % to about 23 wt % of chromium, wherein the ferritic stainless steel is substantially free of nickel.

9. The heat exchanger of claim 6, wherein the tap water is heated by the heat exchange.

10. The heat exchanger of claim 9, wherein the tap water having a temperature of about 0° C. to about 20° C. is heated into hot water having a temperature of about 40° C. to about 60° C. by the heat exchange.

11. A plate-type heat exchanger to be used in a water heating device configured to heat tap water to produce hot water, the plate-type heat exchanger comprising:
a plurality of heat plates, each of which comprises a body portion having a plate shape and an extension portion extending outward from one end of the body portion, the heat plates being stacked on each other in a predetermined direction so that two neighboring extension portions overlap each other; and
bonding parts, each of which is provided between the two neighboring extension portions to bond the two neighboring heat plates,
wherein the heat plate is made of ferritic stainless steel containing less than about 0.5 wt % of nickel, about 0.1 wt % to about 2 wt % of copper, and about 0.03 wt % or less of carbon, and
the bonding part is formed by brazing with a copper filler metal.

12. The plate-type heat exchanger of claim 11, wherein a herringbone pattern of valleys and crests is defined in the body portion.

13. The plate-type heat exchanger of claim 11, wherein the extension portion inclinedly extends outward from the one end of the body portion.

14. The plate-type heat exchanger of claim 11, wherein the content of residual chlorine in the tap water is about 2 ppm or more.

15. A water heating device configured to heat tap water to produce hot water, the water heating device comprising:
a heat source unit; and
a plate-type heat exchanger configured to heat the tap water using heat that is generated in the heat source unit or using heating water that is heated by the heat generated in the heat source unit,
wherein the plate-type heat exchanger comprises:
a plurality of heat plates, each of which comprises a body portion having a plate shape and an extension portion extending outward from one end of the body portion, the heat plates being stacked on each other in a predetermined direction so that two neighboring extension portions overlap each other; and
a plurality of bonding parts, each of which is provided between the two neighboring extension portions to bond the two neighboring heat plates,
wherein the heat plate is made of ferritic stainless steel containing less than about 0.5 wt % of nickel, about 0.1 wt % to about 2 wt % of copper, and about 0.03 wt % or less of carbon, and
the bonding part is formed by brazing with a copper filler metal.

16. The water heating device of claim 15, wherein the extension portion inclinedly extends outward from the one end of the body portion.

17. The water heating device of claim 15, wherein the content of residual chlorine in the tap water is about 2 ppm or more.
